(19) United States
(12) Patent Application Publication
(10) Pub. No.: US 2014/0359318 A1
(43) Pub. Date: Dec. 4, 2014

(54) POWER ADAPTERS

(71) Applicants: Chun-Ting Liu, Taipei (CN); John W. Chow, Taipei (CN)

(72) Inventors: Chun-Ting Liu, Taipei (CN); John W. Chow, Taipei (CN)

(73) Assignee: Hewlett-PackardDevelopment Company, L.P., Houston, TX (US)

(21) Appl. No.: 14/371,606

(22) PCT Filed: Apr. 27, 2012
(86) PCT No.: PCT/US2012/035384

§ 371 Date: Jul. 10, 2014

(51) Int. Cl. G06F 1/26

(52) U.S. Cl. CPC G06F 1/266; G06F 1/26
USPC 713/300; 307/11

(57) ABSTRACT

Power adapters are disclosed. An example power adapter includes a housing. The example power adapter also includes a power converter to convert an input power to an output power. The example power adapter also includes a communication pod carried by the housing, the port to receive data from a first device. The example power adapter also includes a terminal to transfer power from the power converter to the second device, and to transmit the data received from the first device to the second device. The example power adapter also includes a communication line to communicate the data from the communication port to the terminal.

### BACKGROUND

Mobile computing platforms such as laptop computers, tablet computers, smart phones, etc. often receive power from a power source via an adapter. For example, when the power source from which the computing platform is to receive power is an alternating current (AC) power source, such as a typical wall outlet in the United States, the alternating current is converted into direct current (DC) by a power adapter before being supplied to the computing platform.

### BRIEF DESCRIPTION OF THE DRAWINGS

FIG. 1 illustrates an example power adapter disclosed herein.

FIG. 2 illustrates a first example computing platform in communication with the example power adapter of FIG. 1,

FIG. 3 illustrates a second example computing platform in communication with the example power adapter of FIGS. 1 and/or 2 via a docking station.

FIG. 4 is a flowchart representative of an example operation of the example power adapter of FIGS. 1-3.

FIG. 5 is a flowchart representative of an example operation of the example power adapter of FIGS. 1-3 including machine readable instructions that may be executed to implement the example power adapter of FIGS. 1-3.

FIG. 6 is a block diagram of an example processor platform capable of executing the example machine readable instructions of FIG. 5 to implement the example power adapter of FIGS. 1-3.

### DETAILED DESCRIPTION

Computing devices use different types of connectors, ports, standards, protocols, etc. to place one device in communication with another. Different types of connectors and/or ports are differently shaped and sized with respect to, for example, width, depth, thickness, and/or any other dimension(s) and/or characteristic(s). That is, some ports and/or connectors are thicker, wider and/or deeper than other ports and/or connectors. Further, different connectors and/or ports have different capabilities with respect to, for example, data rate, power transfer capabilities, etc. In some instances, different versions of a standard and/or protocol have differently shaped and/or sized connectors and/or ports that may have different capabilities. For example, Universal Serial Bus (USE) ports and connectors are often used to communicate data among computing devices and/or to supply power to computing device(s). Several versions of the USE standard have been released, some of which involve different types of connectors and counterpart ports.

While some computing devices such as desktop computers have form factors large enough to accommodate ports and/or connectors of different sizes, some computing devices do not. For example, smart phones, tablets, cameras, video cameras, handheld global positioning system (GPS) devices, etc. are often designed with compactness in mind and, thus, have relatively small (e.g., thin) form factors. In some instances, the form factor of a housing of a handheld computing device is not large (e.g., is not thick, wide, deep, etc.) enough to accommodate certain types of ports and/or connectors. For example, a tablet may have a form factor large enough to accommodate a Micro-B USE port, but not large enough to accommodate a Standard-A USE pod. As a result, such a tablet is limited to the capabilities of the Micro-B USB standard, which with respect to data transfer rate and power transfer capacity, are less than the capabilities of the Standard-A USE standard.

The inability to accommodate certain types of ports due to size constraints of a housing presents challenges to compact computing devices. For example, certain types of operating systems and/or other types of software require computing devices to include certain type(s) of ports. In some instances, a Standard-A USE port is required to run a particular operating system. Therefore, in previous applications, compact computing devices were prohibited from using some types of operating systems and/or other software.

Further, some compact computing devices include one physical communication port that is used for powering and/or charging the device. In such instances, the lone communication port of the device is unavailable to transport data when the device is being powered and/or charged via the communication port.

Example methods and apparatus disclosed herein provide compact computing devices (e.g., smart phones, tablets, etc.) with access to communication ports that are too large (e.g., Standard-A USE ports) to be included on the housings of the compact computing devices. By providing compact computing devices with access to such communication ports, example methods and apparatus disclosed herein enable the compact computing devices to utilize the increased capabilit(ies) of the otherwise unavailable (e.g., due to size incompatibility) communication port(s), to install and/or utilize software that requires access to the otherwise unavailable communication port(s), and/or to be placed in communication with other computing devices that utilizes (e.g., require) the otherwise unavailable communication port(s). While example methods and apparatus disclosed herein are particularly useful for providing compact computing devices with access to relatively larger communication ports, example methods and apparatus disclosed herein are additionally useful to computing devices of any size, as a greater amount of communication ports is typically beneficial (e.g., to enable the computing device to communicate with a greater number of devices, such as printer(s), speaker(s), network device(s), a keyboard, a mouse, etc.). Further, example methods and apparatus disclosed herein are also useful for providing access to many sizes of communication port(s) to many type(s) of computing device. Indeed some example methods and apparatus disclosed herein provide access to any type (e.g., size) of communication port to any type (e.g., size) of computing device.

To provide computing devices with access to communication port(s), example power adapters disclosed herein include communication port(s). Such power adapters may be used to couple power sources (e.g., wall outlets) to computing device(s). Example methods and apparatus disclosed herein recognize that as computing devices become smaller and smaller, the relatively larger (e.g., thicker) power adapters used by the computing devices include housing real estate that can be utilized to provide communication port(s) to the computing devices. In some instances, size is less of an issue for power adapters than for the computing devices. Moreover, components of many power adapters utilize a housing having a relatively large size (e.g., to accommodate transformer dimensions).

Thus, in addition to transferring power to a computing device from a power source, example power adapters disclosed herein are capable of exchanging data between the computing device and a peripheral device via communication port(s) carried by the housing of the example power adapters. As described in greater detail below, a cord of example power adapters disclosed herein includes line(s) (e.g., wires) that transfer power to the computing device and line(s) (e.g., wires) that communicate data between the computing device and the communication port(s) of the power adapters. The cord of the example power adapters disclosed herein is coupled to, for example, a DC_IN port of the computing device. As a result, the example power adapters disclosed herein transfer power from a power source to the computing device, as well as data from the peripheral device coupled to the communication port(s) to the computing device via the cord coupled to the DC_IN port of the computing device. Additionally, the example power adapters disclosed herein transfer power from the power source to the peripheral device.

The device coupled to the communication port(s) of the example power adapters disclosed herein is referred to as a peripheral device to distinguish the device coupled to the communication port(s) from the computing device being powered by the adapter. However, as used herein, the term “peripheral device” does not limit the type of device that can be coupled to the communication ports of the example power adapters disclosed herein. Rather, any suitable type of device can be coupled to the communication ports of example power adapters disclosed herein.

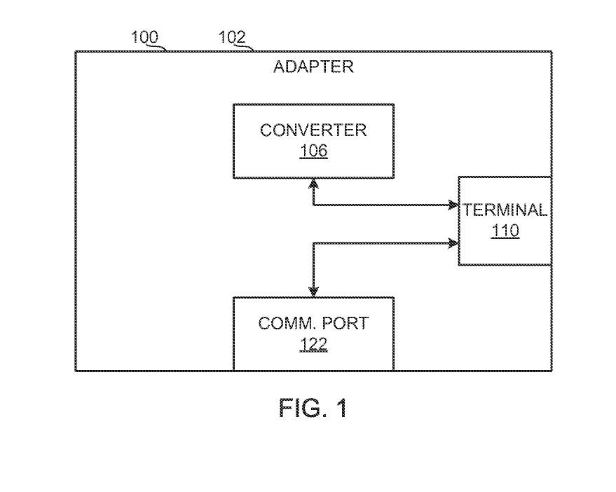

FIG. 1 illustrates an example power adapter 100 implemented in accordance with the teachings of this disclosure. The example power adapter 100 of FIG. 1 includes a housing 102 having an interior volume sufficient to house a plurality of components. The example housing 102 of FIG. 1 is a plastic housing shaped as a rectangular box. However, the housing 102 can be of any suitable material, form factor, and/or shape. The example power adapter 100 of FIG. 1 includes a converter 106 that converts an input power to an output power. The input power is received from, for example, a wall outlet.

The example power adapter 100 of FIG. 1 includes a terminal 110 in communication with the converter 106. The example terminal 110 receives power from the converter 106 and provides the power to, for example, a first computing device coupled to the terminal 110.

The example power adapter 100 of FIG. 1 includes a communication port 122 to place the example power adapter 100 in communication with, for example, a second computing device via a connector coupled to the second computing device. The example communication port 122 of FIG. 1 is capable of transferring data from the second computing device coupled to the communication port 122 to the first computing device coupled to the terminal 110. Further, the example terminal 110 is capable of transferring data from the first computing device coupled to the terminal 110 to the communication port 122. In such instances, the example communication port 122 transmits the data received from the terminal 110 to the second computing device coupled to the communication port 122.

Thus, the example power adapter 100 of FIG. 1 provides power to first computing device via the terminal and enables an exchange of information between first computing device coupled to the terminal 106 and the second computing device coupled to the communication port 122.

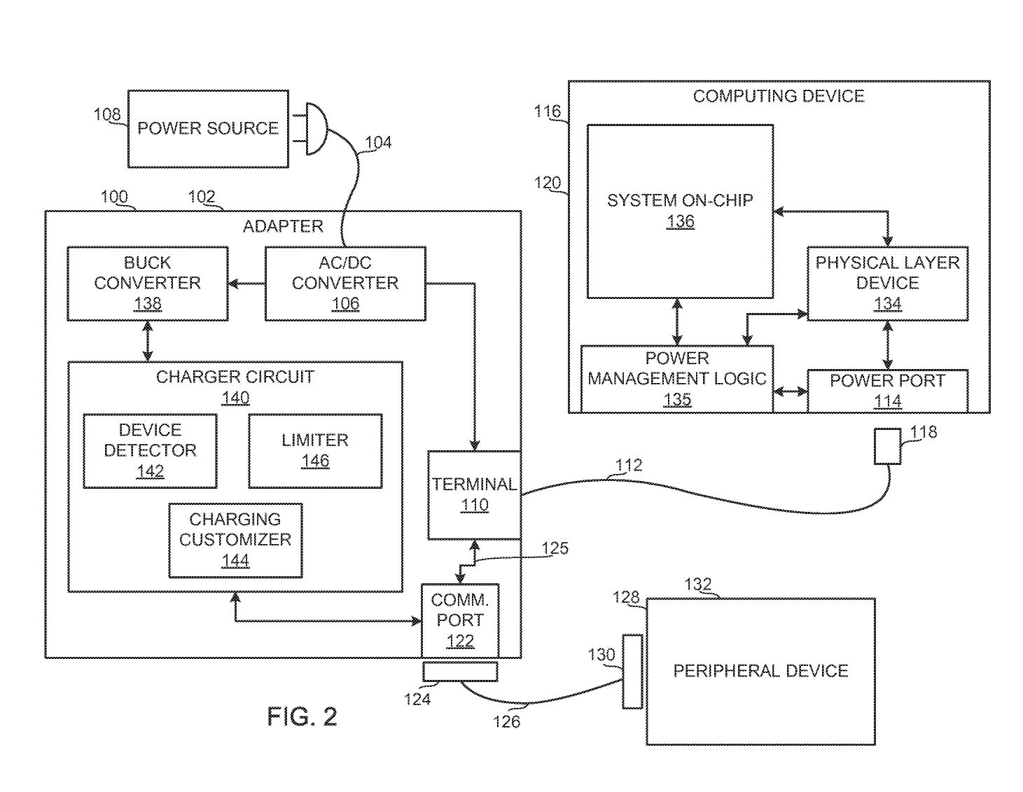

FIG. 2 illustrates an example implementation of the power adapter 100 of FIG. 1. The example power adapter 100 of FIG. 2 includes a first transmission line 104 coupled to a converter 106 that converts an input power to an output power. For example, the converter 106 converts alternating current (AC) to direct current (DC). In some examples, the power adapter 100 includes additional or alternative types of power converter(s) and/or conditioning circuitry. The first transmission line 104 has a pronged connector configured to be coupled (e.g., plugged into) a power source 108 such as, for example, a wall outlet communicatively coupled to a source of electrical current (e.g., a generator, a power company, etc.). When the first transmission line 104 of FIG. 2 is coupled to the power source 108, AC power is delivered to the AC/DC converter 106. The AC/DC converter 106 converts the AC power into DC power. The AC/DC converter 106 of FIG. 2 delivers the DC power to an terminal 110 of the example power adapter 100.

The example power adapter 100 includes a second transmission line 112 that couples the terminal 110 of the example power adapter 100 to a power port 114 of a computing device 116. In the illustrated example of FIG. 2, the power port 114 is a DC_IN port configured to receive a connector 118 at the end of the second transmission line 112. Any suitable type of connector and/or any suitable type of DC_IN port can be utilized by the example power adapter 100 of FIG. 2. In the illustrated example of FIG. 2, the computing device 116 is a compact computing device, such as a smart phone or tablet, having a housing 120 having relatively small form factor compared to, for example, a desktop computer. In the illustrated example of FIG. 2, the housing 120 of the example computing device 116 is too thin to accommodate certain type(s) of ports. In other words, the example housing 120 of FIG. 2 is not thick enough to have certain type(s) of connector(s) mounted to the housing 120. For example, the housing 120 is too thin to accommodate a Standard-A USB port. However, the example power adapter 110 of FIG. 2 can be utilized in conjunction with any type of computing device having a housing of any form factor, size and/or shape.

The example power adapter 100 of FIG. 2 includes a communication port 122 mounted to the housing 102 such that the communication port 122 is accessible (e.g., can receive a counterpart connector) on the exterior of the housing 102. In the illustrated example of FIG. 2, the communication port 122 is a Standard-A USB port which, as described above, cannot be accommodated by the example computing device 116 of FIG. 2 due to its form factor. In some examples, the power adapter 100 includes additional and/or alternative type(s) of communication port(s) and/or more than one communication port. The example communication port 122 of FIG. 2 is configured to receive a first connector 124 of a certain type, such as Standard-A USB connectors. The example first connector 124 of FIG. 2 is attached to a wire 126 capable of coupling a peripheral device 128 to the communication port 122 via a second connector 130. In some examples, the first and second connectors 124 and 130 of the wire 126 are the same type of connectors. In some examples, the first connector 124 is a first type of connector and the second connector 130 is a second type of connector different from the first type. In some examples, the wire 126 does not include the second connector 130 and, instead, is integrally coupled to an internal component of the peripheral device 128. In some examples, the peripheral device 128 has a connector (e.g., a Standard-A USB connector) mounted to the exterior of a housing 132 of the peripheral device 128. In such instances, the example communication port 122 receives the connector mounted to the exterior of the housing 132 of the peripheral device 128.

The example peripheral device 128 of FIG. 2 is any type of device capable of communicating data to the example computing device 116 and/or receiving data from the example computing device 116. In some examples, the peripheral device 128 includes a mass memory device onto which a user of the computing device 116 wishes to transfer data for storage. In some examples, the peripheral device 128 includes a debugging tool that enables a user to debug the example computing device 116. In some examples, the peripheral device 128 is a media storage device from which a user wishes to download media onto the computing device 116.

The example communication port 122 of FIG. 2 is coupled to the terminal 110 which, as described above, is coupled to the second transmission line 112. When the example communication port 122 receives data from the peripheral device 128, the received data is transmitted from the communication port 122 to the terminal 110 via internal communication line(s) 125. The example terminal 110 transmits the data received from the communication port 122 via the second transmission 112, which presents the data to the power port 114 of the example computing device 116. As described above, the example second transmission line 112 of FIG. 2 also transfers power from the terminal 110 to the power port 114 of the computing device 116. In the illustrated example, the second transmission line 112 includes wire(s) and/or cable(s) (or any suitable type of wired transmission medium) over which DC power is transferred from the terminal 110 to the power port 114 of the computing device 116. Further, the example second transmission line 112 of FIG. 2 includes wire(s) and/or cable(s) (or any suitable type of wired transmission medium) over which the data received from the communication port 122 is transmitted from the terminal 110 to the power port 114 of the computing device 116. Additionally, the example second transmission line 112 of FIG. 2 facilitates transfer of data from the computing device 116 to the peripheral device 128 via the communication port 122. In other words, the wire(s) and/or cable(s) of the example second transmission line 112 of FIG. 2 that communicate data are capable of exchanging data between the peripheral device 128 and the computing device 116 in both directions.

In the illustrated example of FIG. 2, the computing device 116 includes a physical layer device 134 coupled to the power port 114. The example physical layer device 134 of FIG. 2 includes, for example, a Peripheral Component Interconnect (PCI) bus that is coupled to the power port 114. However, the power port 114 of the example computing device 116 can be coupled to additional or alternative type(s) of data bus and/or other types of physical layer devices. For example, when the example communication port 122 is a Standard-A USB port, the example physical layer device 134 of FIG. 2 includes a USB PHY Transceiver with a ULPI interface connected to SoC 136. In the example of FIG. 2, the power delivered from the power source 108 to the power port 114 via the example power adapter 100 is conveyed to power management logic 135 of the example computing device 116. The example power management logic 135 includes, for example, power converters (e.g., DC-to-DC converters) that condition the power for different components of the example computing device 116. For example, the power management logic 135 conditions power for the physical layer device 134 and delivers the conditioned power to the physical layer device 134 of FIG. 2.

Further, the example physical layer device 134 of FIG. 2 receives data delivered from the peripheral device 128 via the communication port 122 and the terminal 110 of the example power adapter 100. In other words, the example physical layer device 134 is powered via the example AC/DC converter 106 of the power adapter 100 and also receives data from the example peripheral device 128 via the communication port 122 of the power adapter 100.

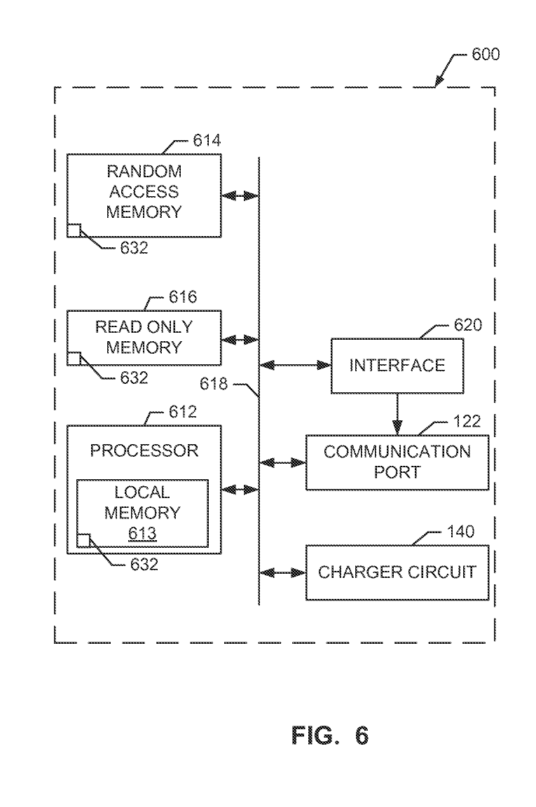

The example physical layer device 134 of FIG. 2 is in communication with one or more processing and/or logic components of the computing device 116 that are represented in FIG. 2 by a system on-chip (SoC) 136. The example SoC 136 of FIG. 2 includes a processor, such as the processor 612 of FIG. 6, which is described below. The example power management logic 135 of FIG. 2 conditions power for the SoC 136 and delivers power to the SoC 135 in accordance with the demands and/or specifications of the SoC 136. In the illustrated example of FIG. 2, the physical layer device 134 transmits the data received from the peripheral device 128 to the processor of the SoC 136. Additionally, the example physical layer device 134 of FIG. 2 receives data from the processor of the SoC 136 addressed to the peripheral device 128 and transmits the data to the peripheral device 128 (e.g., via the terminal 110 and the communication port 122 on the example power adapter 100). Accordingly, the example physical layer device 134 facilitates communication of data between the SoC 136 and the peripheral device 128 (or any other device coupled to the example communication port 122). In some examples, the SoC 136 is programmed with one or more applications (e.g., drivers) that enable the SoC 136 to communicate with peripheral devices, such as the example peripheral device 128 of FIG. 2. The SoC 136 of the illustrated example is programmed to obtain such application(s) via, for example, a download from the Internet, a disk, and/or a peripheral device coupled to the SoC 136 via the example communication port 122 of FIG. 2.

In addition to transferring power from the power source 108 to the computing device 116 and exchanging data between the peripheral device 128 and the computing device 116, the example power adapter 100 of FIG. 2 transfers power from the power source 108 to the peripheral device 128 via the communication port 122. In the illustrated example of FIG. 2, the protocol by which the communication port 122 operates enables charging of devices coupled to the communication port 122. In the example of FIG. 2, the communication port 122 is a Standard-A USB port, which is capable of communicating data and transferring power. To provide power to the communication port 122 for transfer to the peripheral device 128, the example power adapter 100 of FIG. 2 includes a buck converter 138 and a charger circuit 140. In some examples, the AC/DC converter 106 acts as a buck converter for the adapter 100. In other words, the conversion provided by the example buck converter 138 of FIG. 2 and the example AC/DC converter 106 can be performed by a single power converter. In the illustrated example, the example buck converter 138 receives DC power from the AC/DC converter 106 and steps the DC power down to a level suitable for the example communication port 122. In other words, the example communication port 122 of FIG. 2 has limitations on the amount of power and/or the voltage levels that can be transferred to, for example, the peripheral device 128. In the illustrated example, the amount of power that can be delivered via the communication port 122 is less than the amount of power output by the example AC/DC converter 106. Therefore, the example buck converter 138 steps down the amount of power output by the AC/DC converter 106 before the power is delivered to the example communication port 122 of FIG. 2.

In the example of FIG. 2, the output of the buck converter 138 is provided to the charger circuit 140. The example charger circuit 140 of FIG. 2 includes a device detector 142 to identify the peripheral device 128 when the peripheral device 128 is coupled to the example communication port 122. For example, the device detector 142 determines a model number of the peripheral device 128, a manufacturer of the peripheral device 128, a version of the peripheral device 128, a type of the peripheral device 128, etc. Additionally, the example device detector 142 of FIG. 2 determines a charging profile of the peripheral device 128. In some examples, the charging profile of the peripheral device 128 is stored in memory of the peripheral device 128 and the example device detector 142 receives the charging profile from the memory of the peripheral device 128 via the communication port 122. In some examples, the device detector 142 infers the charging profile of the peripheral device 128 from other information (e.g., the model number and/or manufacturer) received from the peripheral device 128.

The example device detector 142 of FIG. 2 provides the identified charging profile of the peripheral device 128 to a charging customizer 144. The example charging customizer 144 of FIG. 2 tailors the delivery of power from the buck converter 138 to the example communication port 122 to meet the specification of the corresponding peripheral device. The example charging profile associated with the peripheral device 128 identifies the power specifications of the peripheral device 128. For example, the charging profile includes a first mode (e.g., stand by) of the peripheral device 128 during which a first amount of power is to be delivered and a second mode (e.g., making a phone call) of the peripheral device 128 during which a second amount of power different from the first amount of power is to be delivered to the peripheral device 128. The example charging customizer 144 accommodates additional or alternative aspects of the charging profile for the peripheral device 128.

The example charger circuit 140 of FIG. 2 includes a limiter 146 to limit an amount of power (e.g., an amount of current and/or an amount of voltage) delivered to the communication port 122 based on power demands of the computing device 116. In some examples, the limiter 146 restricts the amount of power to be delivered to the communication port 122 to a predetermined amount of power. When the computing device 116 demands an amount of power that exceeds normal operational expectations from the example power adapter 100 (e.g., upon initialization of the computing device 116), the example limiter 146 reduces the amount of power that is delivered to the communication port 122. When the computing device 116 demands an amount of power that corresponds to normal operational expectations (e.g., within a threshold) or an amount of power that is lower than normal operational expectations, the example limiter 146 does not reduce the amount of power delivered to the communication port 122. The amount of power demanded by the computing device 116 is determined by, for example, a current sense resistor and/or any other sensor(s). The example limiter 146 allows the example peripheral device 128 to be charged via the example communication port 122, but not at the expense of the computing device 116 when the computing device 116 has a high demand for power.

In some instances, the example second transmission line 112 is not coupled to a power-drawing device or any device. If so, the example power adapter 100 delivers power from the power source 108 to the communication port 122 to, for example, charge the peripheral device 128. In such instances, the example limiter 146 does not limit the power delivery to the communication port 122 because the power demand at the second transmission line 112 is zero or substantially zero.

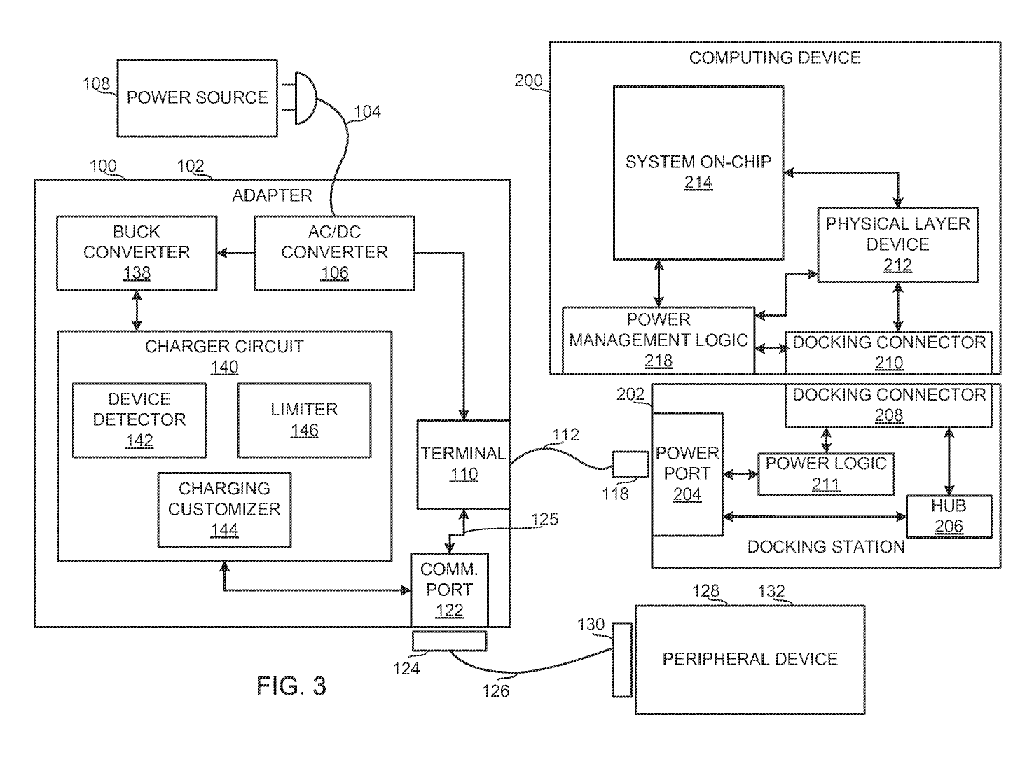

FIG. 3 illustrates the example power adapter 100 of FIGS. 1 and/or 2 in communication with a computing device 200 via a docking station 202. The example of FIG. 3 also includes the example peripheral device 128 of FIG. 1 in communication with the example communication port 122. As described above in connection with FIG. 2, the communication port 122 of the example power adapter 100 enables communication of data between the peripheral device 128 and the computing device 200 via the internal line 125 and the terminal 110. In the example of FIG. 3, the terminal 110 is in communication with the docking station 202. In particular, the example power adapter 100 transmits data from the peripheral device 128 to the docking station 202 via the terminal 110 and the second transmission line 112. As described above in connection with FIG. 2, the example second transmission line 112 delivers power and data to a power port coupled to the connector 118 of the second transmission line 112. In the illustrated example of AG. 3, the connector 118 of the second transmission line 112 is coupled to a power port 204 of the example docking station 202. In other words, the power port 204 of the example docking station 202 receives power from the power source 108 and data from the peripheral device 128 via the example power adapter 100.

The example docking station 202 of FIG. 3 includes a hub 206 in communication with the example power port 204. In some examples, the hub 206 is in communication with additional ports mounted to the housing of the docking station 202 such as, for example, USE port(s), Ethernet port(s), memory card reader(s), etc. In such instances, additional peripheral devices can be coupled to the docking station 202 for communication with the example computing device 200. The example hub 206 routes data received at the power port 204 to a docking connector 208 that is configured to be coupled to a counterpart docking connector 210 of the example computing device 200. The docking connector 208 of the example docking station 202 and the docking connector 210 of the example computing device 200 include a plurality of pins that communicate signals according to a mapping of the pins between the connectors 208 and 210. In some examples, the docking connector 210 is of a similar type of port as the power port 204. Further, in some examples, the docking connector 208 is of a similar type of connector as the connector 118 of the second transmission line 112.

The example docking connector 210 of the computing device 200 routes data signals received from the docking station 202 to a physical layer device 212. As described above in connection with FIG. 2, the example physical layer device 212 is in communication with one or more processing and/or logic components, which are represented in FIG. 3 as a SoC 214. In the illustrated example of FIG. 3, the SoC 214 includes a processor capable of interpreting, processing, and/or responding to the data transmitted to the computing device 200 from the peripheral device 128. The example physical layer device 212 also receives data from the processor of the example SoC 214 destined for the example peripheral device 128. In such instances, the physical layer 212 routes the data to the docking connector 210, which passes the data to the docking station 202 via the docking connector 208. The example docking station 202 transmits the data from the SoC 214 to the example power adapter 100 via the second transmission line 112 coupled to the power port 204. The example communication port 122 of the example power adapter 100 receives the data via the internal communication line 125 and transmits the data to the example peripheral device 128. Accordingly, the example power adapter 100 of FIG. 3 facilitates exchange of data between the example peripheral device 128 and the SoC 214 of the example computing device 200 via the example docking station 202.

Further, the example power adapter 100 facilitates delivery of power to the example computing device 200 via the docking station 202. In the illustrated example of FIG. 3, the docking station 202 includes power logic 216 in communication with the docking connector 208. The example power port 204 delivers power received via the terminal 110 and the second transmission line 112 to the power logic 216. The example power logic 216 of FIG. 3 handles the power to, for example, charge a battery of the docking station 202 and/or otherwise power the docking station 202 and its components. Further, the power logic 216 routes the power to power management logic 218 of the computing device 200 via the docking connector 2 208 and 210. As described above in connection with FIG. 2, the power manager logic 216 conditions the power for the components of the computing device 200, such as the SoC 214 and/or the physical layer device 212. Further, the example power adapter 100 of FIG. 3 facilitates delivery of power to the example peripheral device 128 via the example communication port 122.

While an example manner of implementing the charger circuit 140 of FIGS. 2 and 3 has been illustrated in FIGS. 2 and 3, one or more of the elements, processes and/or devices illustrated in FIGS. 2 and 3 may be combined, divided, re-arranged, omitted, eliminated and/or implemented in any other way. Further, the example device detector 142, the example charging customizer, 144, the example limiter 146 and/or, more generally, the example charger circuit 140 of FIGS. 2 and 3 may be implemented by hardware, software, firmware and/or any combination of hardware, software and/or firmware. Thus, for example, any of the example device detector 142, the example charging customizer 144, the example limiter 146 and/or, more generally, the example charger circuit 140 of FIGS. 2 and 3 could be implemented by one or more circuit(s), programmable processor(s), application specific integrated circuit(s) (ASIC(s)), programmable logic device(s) (PLD(s)) and/or field programmable logic device(s) (FPLD(s)), etc. At least one of the example device detector 142, the example charging customizer 144, the example limiter 146 and/or, more generally, the example charger circuit 140 of FIGS. 2 and 3 are hereby expressly defined to include a tangible computer readable medium such as a computer readable storage medium (e.g., a memory, DVD, CD, Blu-ray, etc. storing the software and/or firmware. Further still, the example charger circuit 140 of FIGS. 2 and 3 may include one or more elements, processes and/or devices in addition to, or instead of, those illustrated in FIGS. 2 and 3, and/or may include more than one of any or all of the illustrated elements, processes and devices.

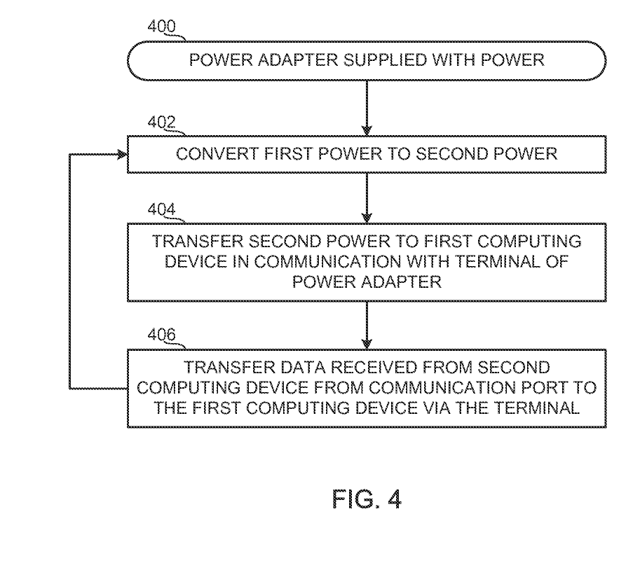

A flowchart representative of an example operation of the example adapter 100 of FIGS. 1-3 is shown in FIG. 4. The example of FIG. 4 begins with the power adapter 100 receiving power from, for example, the power source 108 (block 400). The converter 106 converts first power (e.g., AC power from the power source 108) to a second power (e.g., DC power) (block 402). The example power adapter 100 transfers the second power to a first computing device (e.g., the computing device 116 of FIG. 2) via the terminal 110 (block 404). Further, the example power adapter 100 transfers data received from a second computing device (e.g., the peripheral device 128 of FIG. 2) from the communication port 122 to the first computing device via the terminal 110 (block 406). Control then returns to block 402. Thus, the example power adapter 100 delivers power to a first computing device in communication with the terminal 110, as well as transfers data between the first computing device and the second computing device via the communication port 122 and the terminal 110.

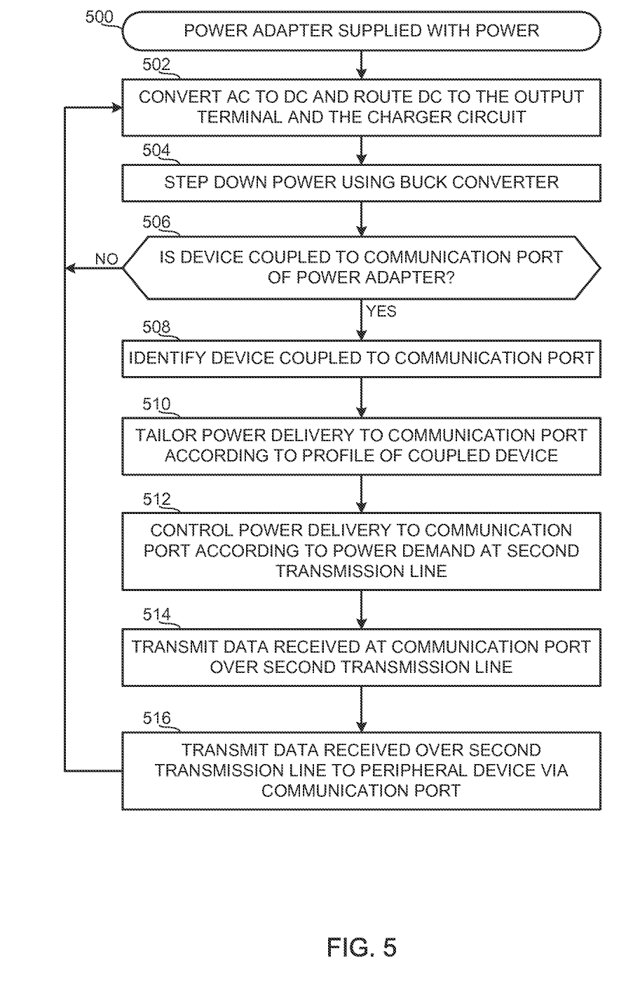

A flowchart representative of an example operation of the example power adapter 100 of FIGS. 1-3 is shown in FIG. 5. Some of the blocks of FIG. 5 are representative of example machine readable instructions for implementing the example power adapter 100 of FIGS. 1-3. In the example of FIG. 5, the machine readable instructions comprise a program for execution by a processor such as the processor 612 shown in the example processor platform 600 discussed below in connection with FIG. 6. The program may be embodied in software stored on a tangible computer readable medium such as a CD-ROM, a floppy disk, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example programs are described with reference to the flowchart illustrated in FIG. 5, many other methods of implementing the example power adapter 100 may alternatively be used. For example, the order of execution of the blocks may be changed, and/or some of the blocks described may be changed, eliminated, or combined.

As mentioned above, the example processes of FIG. 5 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage medium and to exclude propagating signals. Additionally or alternatively, the example processes of FIG. 5 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The example of FIG. 5 begins with the example power adapter 100 being coupled to the example power source 108, thereby supplying the power adapter 100 with power (block 500). In the illustrated example, the power being supplied to the power adapter 100 is AC power. The example AC/DC converter 106 converts the AC power to DC power and routes the DC power to the terminal 110 and the charger circuit 140 (block 502). The conversion of power at the example AC/DC converter 106 continues while the power adapter 100 is supplied with power (e.g., from the power source 108). Further, the example buck converter 138 steps down the DC power received from the AC/DC converter 106 to a level suitable for the power, current, and/or voltage transfer capabilities (e.g., five volts) of the communication port 122 (block 504). The conversion of power at the example buck converter 138 continues while the power adapter 100 is supplied with power (e.g., from the power source 108).

The example device detector 142 of the charger circuit 140 determines whether a device (e.g., the peripheral device 128 of FIGS. 2 and 3) is coupled to the communication port 122 of the power adapter 100 (block 506). If the communication port 122 does not have a device coupled thereto (block 504), the example device detector 142 continues to check for a device being coupled to the communication port 122.

When the device detector 142 determines that a device is coupled to the communication port 122 (block 506), the device detector 142 identifies the coupled device (block 508). In the illustrated example, the device detector 142 identifies the example peripheral device 128 of FIGS. 2 and 3 as the device coupled to the communication port 122. The identification of the peripheral device 128 by the example device detector 142 of FIGS. 2 and 3 includes obtaining a charging profile associated with the peripheral device 128. The example charging customizer 144 of the example charger circuit 140 uses the charging profile to tailor delivery of power to the peripheral device 128 via the communication port 122 (block 510). For example, the charging customizer 144 delivers different amounts of power, current, and/or voltage to the peripheral device 128 at different times depending on a mode of the peripheral device 128. If not charging profile is detected and/or if the peripheral device coupled to the communication port 122 cannot be charged by the power adapter 100, the example charging circuit 140 maintains the power supply (e.g., five volts) to the peripheral device without providing the customized charging of the charging customizer 144.

Further, when the power adapter 100 is coupled to a computing device (e.g., the example computing device 116 of FIG. 2 or the example computing device 200 of FIG. 3 via the example docking station 202) via the second transmission line 112, the example limiter 146 selectively restricts the amount of power delivered to the communication port 122 based on the power demands of the computing device (block 512). In some instances, no restriction is performed. For example, if the power adapter 100 is coupled to the power source 108 via the first transmission line and the peripheral device 128 via the communication port 122, but is not coupled to a device via the second transmission line 112, the example limiter 146 does not limit the power delivered to the communication port 122 because the demand from the second transmission line is zero or substantially zero.

Data received at the example communication port 122 from the peripheral device 128 is transmitted over the example second transmission line 112 (block 514). When the second transmission line 112 is coupled to, for example, the computing device 116 of FIG. 2, the data is presented to the power port 114 and routed to the SoC 136. Further, data received at the example communication port 122 from the second transmission line 112 (e.g., from the SoC 136) is routed to the peripheral device 128 (block 516). Accordingly, the example communication port 122 facilitates exchange(s) of data between the peripheral device 128 and the SoC 136 of the computing device 116. As described above, in the illustrated example, the exchange of data between the peripheral device 128 and the SoC 136 is facilitated over the second transmission line 112, which also transfers power from the power source 108 to the computing device 116. When the second transmission line 112 is not coupled to the computing device 116, the peripheral device 116 can still be charged via the example charging circuit 140. Control returns to block 502.

FIG. 6 is a block diagram of an example processor platform 600 capable of executing the instructions of FIG. 5 to implement the example charger circuit 140 of the example power adapter 100 of FIGS. 1-3. In the illustrated examples, the example power adapter 100 of FIGS. 1-3 houses the example processor platform 400 to implement, for example, the example charger circuit 140 of FIGS. 2 and/or 3.

The processor platform 600 of the instant example includes a processor 612. For example, the processor 612 can be implemented by one or more microprocessors or controllers from any desired family or manufacturer.

The processor 612 includes a local memory 613 (e.g., a cache), In some examples, the processor 612 is in communication with a main memory including a volatile memory 614 and/or a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 also includes an interface circuit 620. The interface circuit 620 may be implemented by any type of interface standard, such as an Ethernet interface, a universal serial bus (USB), and/or a PCI express interface. In the illustrated example, the example communication port 122 of FIGS. 1-3 is in communication with the interface 620 and/or the bus 618. Further, one or more components of the example charger circuit 140 of FIGS. 2 and/or 3 is in communication with the bus 618 and/or the interface 620.

Coded instructions 632 may be stored in the memory 613, in the volatile memory 614, and/or in the non-volatile memory 616. When the example processor platform 600 of FIG. 6 is used to implement the example charger circuit 140 of FIGS. 2 and/or 3, the coded instructions 632 may be stored in a flash memory device, such as the non-volatile memory 616.

Although certain example apparatus, system, methods, and articles of manufacture have been disclosed herein, the scope of coverage of this patent is not limited thereto. On the contrary, this patent covers all apparatus, system, methods, and articles of manufacture fairly falling within the scope of the claims of this patent.

What is claimed is:

1. A power adapter, comprising:
a housing;
a power converter to convert an input power to an output power;
a communication port carried by the housing, the port to be coupled to a first device; and
a terminal to transfer power from the power converter to a second device, and to transmit data received from the first device to the second device.

2. A power adapter as defined in claim 1, further comprising a transmission line to couple the power converter to a power source.

3. A power adapter as defined in claim 1, further comprising a transmission line to couple the terminal to a power port of the second device.

4. A power adapter as defined in claim 1, further comprising a second power converter to transfer power to the first device.

5. A power adapter as defined in claim 4, further comprising a circuit to tailor the output power from the first converter to a specification of the first device.

6. A power adapter as defined in claim 1, further comprising a first wire to transfer the output power from the power converter to the second device, and further comprising a second wire to transmit the data to the second device.

7. A power adapter as defined in claim 1, wherein the communication port is to transmit data received from the second device to the first device.

8. A power adapter as defined in claim 1, further comprising a communication line to communicate the data from the communication port to the terminal.

9. A power adapter, comprising:
a Universal Serial Bus (USB) port to receive data from a first computing device;
a power converter to convert power from a power source to an output power; and
a terminal to present the output power to a second computing device in communication with the terminal via a first transmission line, the terminal to route data from the first computing device coupled to the USE port to the second computing device via the first transmission line.

10. A power adapter as defined in claim 9, wherein the terminal is to receive data from the second computing device via the first transmission line, and the terminal is to route the data received from the second computing device to the first computing device via the USB port.

11. A power adapter as defined in claim 9, wherein the first transmission line is to be coupled to a power port of the second computing device.

12. A power adapter as defined in claim 9, further comprising a second transmission line to couple the power converter to the power source, the first transmission line and the second transmission line being different.

13. A power adapter as defined in claim 9, further comprising a charger circuit to receive the output power from the power converter and to supply adjusted power to the USE port.

14. A power adapter as defined in claim 13, further comprising a limiter to restrict the supply of the adjusted power to the USE port based on a demand of the second computing device.

15. A power adapter as defined in claim 13, further comprising a customizer to tailor the adjusted power based on a profile of the first computing.

16. A method, comprising:
converting first power to second power;
transferring the second power to a first computing device in communication with a terminal of a power adapter; and
transferring data received from a second computing device from a communication port to the first computing device via the terminal.

17. A method as defined in claim 16, further comprising transferring data received from the first computing device via the terminal to the communication port.

18. A method as defined in claim 16, further comprising supplying third power to the communication port.

19. A method as defined in claim 18, further comprising limiting the third power to the communication port based on a demand of the first computing device.

20. A method as defined in claim 18, further comprising adjusting the third power based on the type of the second computing device.
